(19) United States
(12) Patent Application Publication
(10) Pub. No.: US 2005/0113237 A1
(43) Pub. Date: May 26, 2005

(54) Integral seal for centrifuge chamber

(76) Inventors: Keith Rosiello, Shrewbury, MA (US); William Garcia de Quevedo, Miami, FL (US); Keith David Boudreau, Wooburn, MA (US)

Correspondence Address: Brian P. Hopkins, Esq.;Mintz, Levin, Cohn, Ferris, Glovsky and Popeo, P.C, The Chrysler Center, 666 Third Avenue, 24th Floor, New York, NY, 10017, US

(21) Appl. No.: 10/723,499

(22) Filed: Nov. 25, 2003

(51) Int. Cl. B04B 7/12

(52) U.S. Cl. 494/45

(57) ABSTRACT

The present invention is directed to a processing/expressor chamber/bag and/or hub assembly for use in centrifugal processing, in particular, to centrifuge blood processing. Accordingly, such a bag according to some embodiments of the present invention may include a substantially circular enclosure having a central opening, where the central opening includes an integrally formed first mating portion. The hub may include a second mating portion corresponding to the first mating portion. Other embodiments may include methods of assembling the hub and bag, and use of such a bag in a centrifuge system.

The present disclosure is related to co-pending U.S. patent application Ser. No. 10/633,842, filed Aug. 4, 2003, entitled, “EXPANDABLE PROCESSING AND EXPRESSION CHAMBER, co-pending U.S. patent application Ser. No. 10/232,197, filed Aug. 28, 2002, entitled, “BLOOD PRODUCT TRANSFER SYSTEM”, co-pending U.S. patent application Ser. No. 10/211,143, filed Aug. 2, 2002, entitled, “PROCESSING BAG FOR COMPONENT SEPARATOR SYSTEM AND METHOD OF REMOVING SEPARATED COMPONENTS and co-pending U.S. patent application Ser. No. 09/970,547, filed Oct. 3, 2001, entitled, “MULTIPLE PROCESSING CHAMBER SET AND USE THEREOF. Each of the foregoing disclosures, in their entirety, is incorporated herein by reference.

### BACKGROUND OF THE INVENTION

1. Field of the Invention

The invention relates to processing and/or expressor chambers for a material processing device, and more particularly to a flexible processing/expressor chamber/bag for a biological material, centrifugal processing device.

2. Background of the Invention

Flexible processing chambers (e.g., bags) for processing biological cells in a fixed volume centrifuge, and methods for use of such processing bags, e.g., by centrifugation, are known. For example, PCT patent application PCT/US98/10406 describes a flexible cell processing chamber having a rotating seal to keep the contents of the chamber sterile during processing. Flexible processing chambers advantageously are disposable and thus suitable for single-use sterile applications.

For certain applications, such as blood processing including blood component separation, enzymatic conversion of blood type, and pathogen inactivation of blood components, multiple units of material (e.g., blood) are processed at a time, in a single instrument under the same conditions. Co-pending, and jointly assigned U.S. patent application Ser. No. 09/970,547, discloses simultaneous processing of multiple processing chambers/bags which reduce the time and expense required to perform separation and conversion using only a single bag.

A problem with the prior art centrifuge bags is the joining of the bag with a hub for an airtight and sterile seal. While such seals have been accomplished in the past, such methods have been costly and time consuming requiring separate gasket materials to be placed between the two items being joined. Accordingly, there exists a need for a simplified and less expensive method/system for joining centrifuge processing bag with a central hub.

### SUMMARY OF THE INVENTION

Embodiments of the present invention provide a novel hub-chamber/bag assembly for material (e.g., biological or otherwise) processing (for example) in a centrifugal or other processing device.

Accordingly, in a first embodiment of the present invention, a bag for use in centrifugal processing includes a substantially circular enclosure having a central opening. The central opening may include an integrally formed first mating portion for mating with a corresponding second mating portion of a hub. In alternate aspects of the first embodiment, the bag includes two sides each having a central opening with an integrally formed first mating portion.

In another embodiment of the present invention, a bag for use in centrifugal processing includes a substantially circular enclosure having a central opening, where the central opening includes an integrally formed first mating portion. The bag also includes a hub having a second mating portion corresponding to the first mating portion.

In another embodiment of the present invention, a centrifuge is provided and includes one or more bags for housing materials to be separated, or for housing materials for use in expressing materials out from the centrifuge. Each bag comprises a substantially circular enclosure having a central opening, where the opening includes an integrally formed first mating portion and one or more corresponding hubs. Each hub also includes a second mating portion corresponding to the first mating portion of a respective bag.

In yet another embodiment of the invention, a method of sealing a centrifuge bag to a hub includes providing a bag for use in centrifugal processing, where the bag comprises a substantially circular enclosure having a central opening. The central opening includes an integrally formed first mating portion. The method also includes providing a hub having a second mating portion corresponding to the first mating portion, placing the hub within the opening, applying a layer of an adhesive material to at least one of the first mating portion and the second mating portion and mating the first mating portion with the second mating portion. Other aspects of this embodiment include curing the adhesive material. For UV cure hub material must have a minimum level of visual clarity to allow full and proper adhesive curing.

In yet another aspect of the present invention, a method of sealing a centrifuge bag to a hub includes providing a bag for use in centrifugal processing, where the bag comprises a substantially circular enclosure having a central opening having a first mating portion. The method also includes providing a hub having a second mating portion corresponding to the first mating portion, placing the hub within the opening and mating the first mating portion with the second mating portion.

In still yet another aspect of the present invention, a hub for use with a centrifugal bag includes one or more channels for directing fluids into and/or out of a centrifuge bag and an integrally formed first mating portion for mating with a corresponding second mating portion of the centrifuge bag.

These and other aspects of the invention will be described in connection with the drawings and the detailed description below.

### BRIEF DESCRIPTION OF THE DRAWINGS

FIG. 1 illustrates an example of a centrifugal processing apparatus for use with one or more flexible processing/expressor chambers according to some embodiments of the present invention.

FIG. 2A is top planer view of a processing/expressor chamber for use with a centrifuge according to another embodiment of the present invention.

FIG. 2B is a perspective view of the processing/expressor chamber according to the embodiment of the invention illustrated in FIG. 2A.

FIG. 2C is a cross-sectional view of the processing/expressor chamber according to the embodiment of the invention illustrated in FIG. 2A.

FIG. 3A is a side planer view of the hub according to an embodiment of the invention.

FIG. 3B is an enlarged side view of the hub according to the embodiment of the invention illustrated in FIG. 3A.

FIG. 3C is a top side perspective view of a hub for mounting a centrifuge processing/expressor chamber according to an embodiment of the present invention.

FIG. 3D is a top planer view of the hub according to the embodiment of the invention illustrated in FIG. 3A.

FIG. 4 is a perspective view of a processing/expressor chamber mated to a hub according to an embodiment of the present invention.

FIG. 5 is a perspective view of an assembled plurality of processing/expressor chambers according to another embodiment of the present invention.

FIG. 6A illustrates an exploded, cross-sectional view of a bag and hub combination with weld rings according to another embodiment of the present invention.

FIG. 6B illustrates an assembled, cross-sectional view of the bag and hub combination with the weld rings according to the embodiment of the invention illustrated in FIG. 6.

### DETAILED DESCRIPTION OF THE EMBODIMENTS

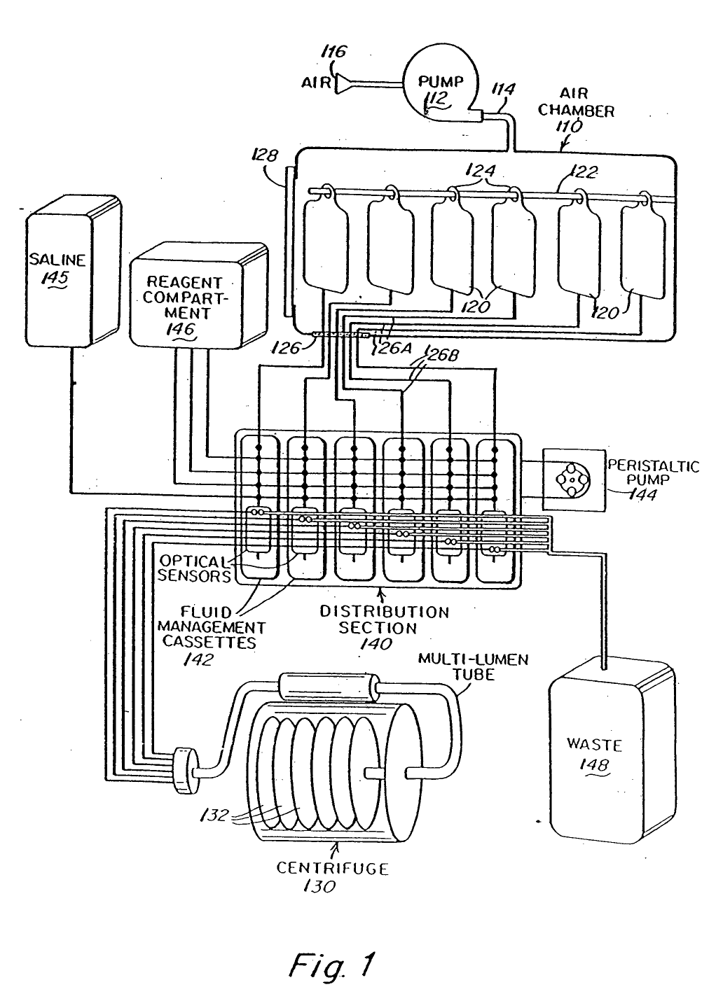

FIG. 1 illustrates a block diagram of a processing system embodying an exemplary device according to one embodiment of the present invention for processing biological cells (e.g., blood). Blood product, for example, is transferred from at least one blood storage bag to a centrifuge for processing. Reference is made to U.S. Pat. No. 6,175,420 to Barry et al., granted Jan. 16, 2001 for a more comprehensive description of the processes and devices employed by such a system. Reference may also be made to U.S. Pat. No. 5,665,048 to Jorgensen, granted Sep. 9, 1997 for further descriptions relating to the centrifuge itself. Both foregoing patents are incorporated herein by reference, in their entirety.

Although embodiments of the present invention may be used with a biological/blood processing apparatus, the embodiments are equally applicable to other uses separate and apart from biological material processing, and/or separate and apart from centrifugal processing.

Accordingly, FIG. 1 illustrates one device and process which enables the transfer a blood product to the centrifuge using, for example, air pressure, as disclosed in co-pending and jointly owned U.S. patent application Ser. No. 10/232,197, filed Aug. 28, 2002, the entire disclosure of which is herein incorporated by reference. In this example, an airtight vacuum/pressure chamber 110 is coupled to an associated pump 112 by way of the tubing 114, which pumps or expels air from source 116 (e.g. ambient air). Within the chamber 110 are a series of blood product storage bags 120. Each of these bags may be supported from a hanger 122 by means of a securing loop 124 associated with each bag. Individual lines or tubing from each bag 126A, 126B couples through the wall of the chamber by way an airtight fixture 126, positioned between the interior and exterior portions of the vacuum/pressure chamber of the chamber 110.

The processing device also includes a centrifuge 130 having one or more associated centrifuge processing bags 132 (which may also include expressor bags) and a distribution section 140 comprising one or more fluid management cassettes 142 and a peristaltic pump 144. Also coupled to the cassettes 142 is a saline supply or bag 145 and reagent compartment 146, and a waste bag 148 relating to the fluid management cassettes. Not specifically illustrated in FIG. 1, but considered as part of the system, is a computer controller which controls the operation of the device and processing of material.

The flexible chamber/bag assembly according to the present invention may provide multiple and/or expandable processing and chamber sets for processing simultaneously and independently a number of separate samples at one time in a centrifugal cell processing device (for example). The multiple processing chamber sets permit sterile addition and removal of samples (and processed fractions thereof), processing fluids (including enzymes, salts, buffers and other process chemicals), and waste products without the need for rotating seals of any kind. Thus, the multiple processing chamber set represents a portion of a closed system for biological cell processing and includes a number of separate closed containers that can be treated in series or in parallel. Further details of such a system may be found in co-pending and jointly assigned U.S. patent application Ser. No. 09/970,547 (the '547 application), the entire disclosure of which is also incorporated by reference.

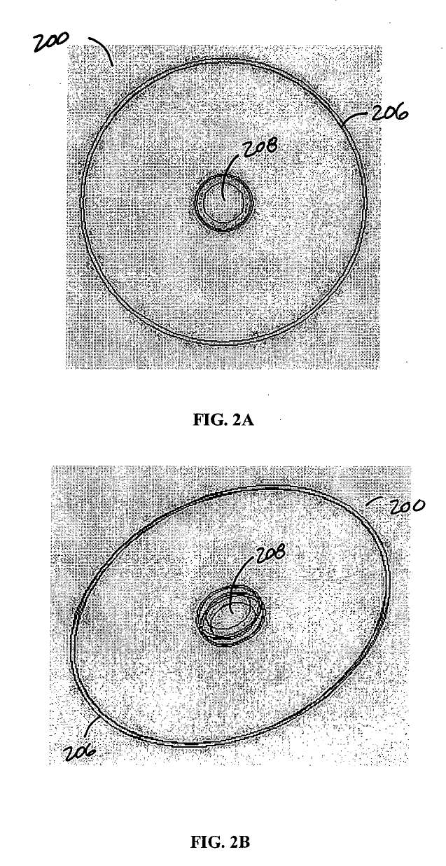

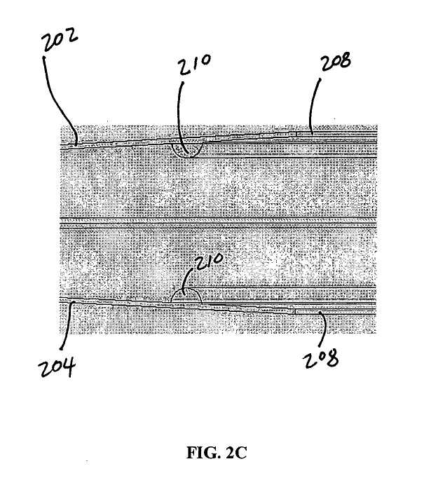

As shown in FIGS. 2A-2C, a processing or expressor bag 200, according to embodiments of the present invention, may include a first side 202 and a second side 204 connected to the first side radially via edge 206. Each side may include an axial opening 208 for housing a central hub. The hub may be used so that multiple processing/expressor bags may be assembled together. An example of such a hub may be found in the '547 application. In that regard, FIG. 4 illustrates an example of a processing bag 400 having a hub 402 provided in the axial opening on at least one side of the bag 400 (typically both sides of the bag).

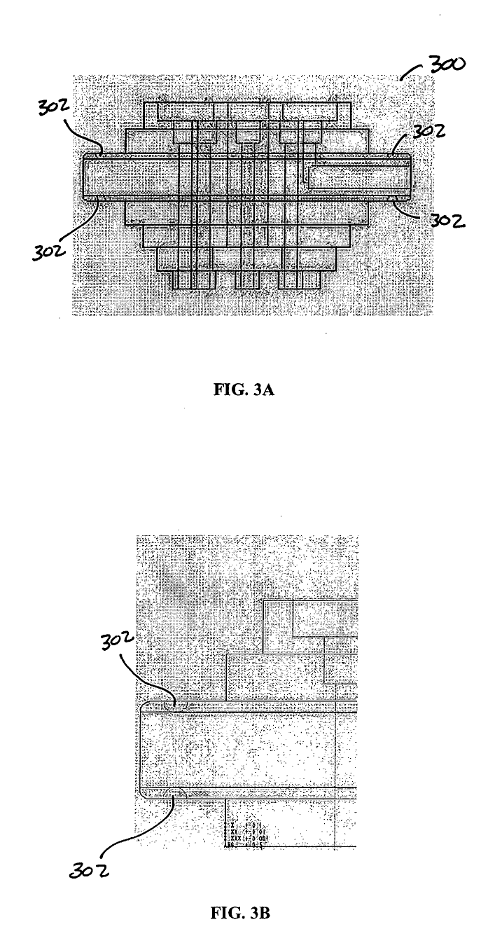

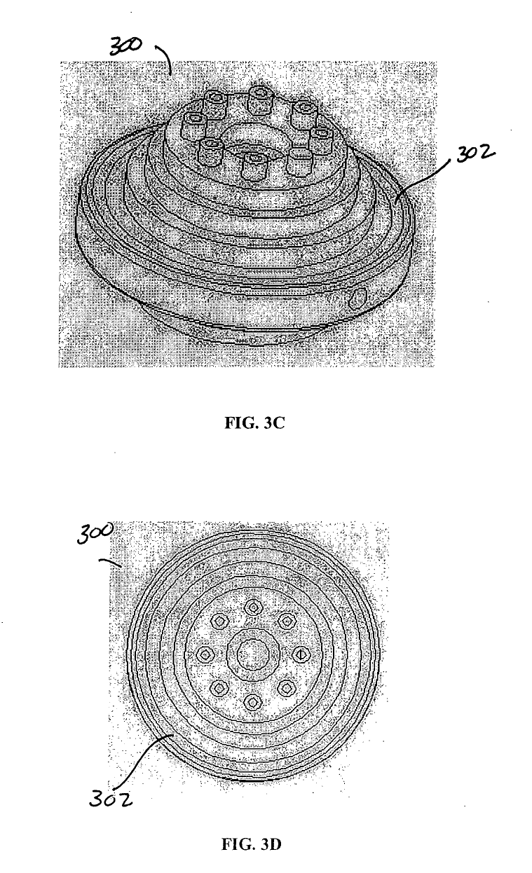

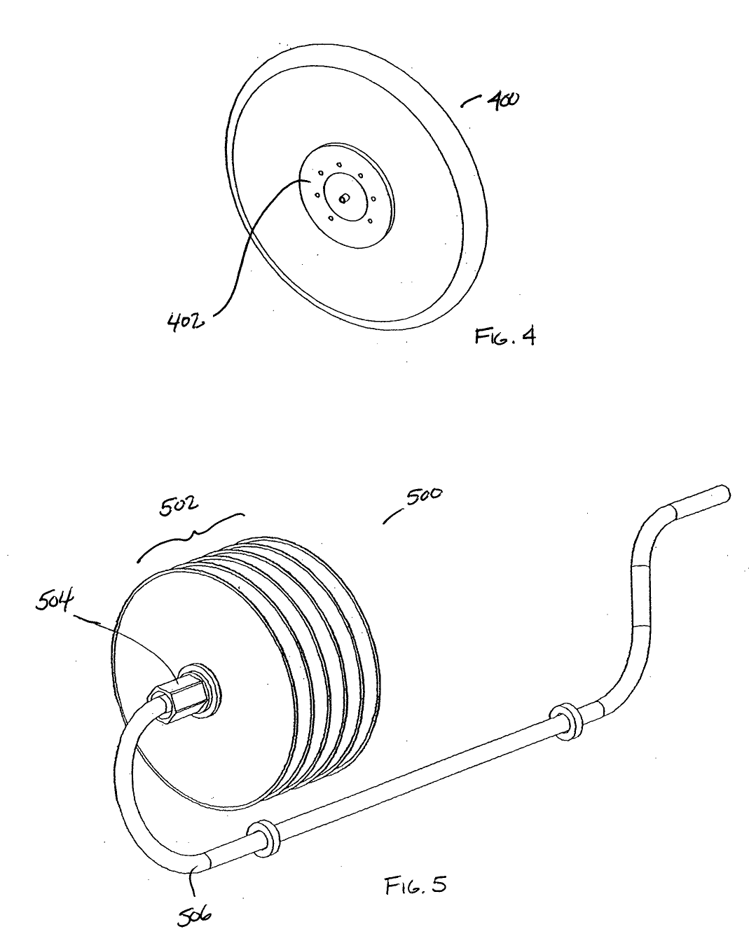

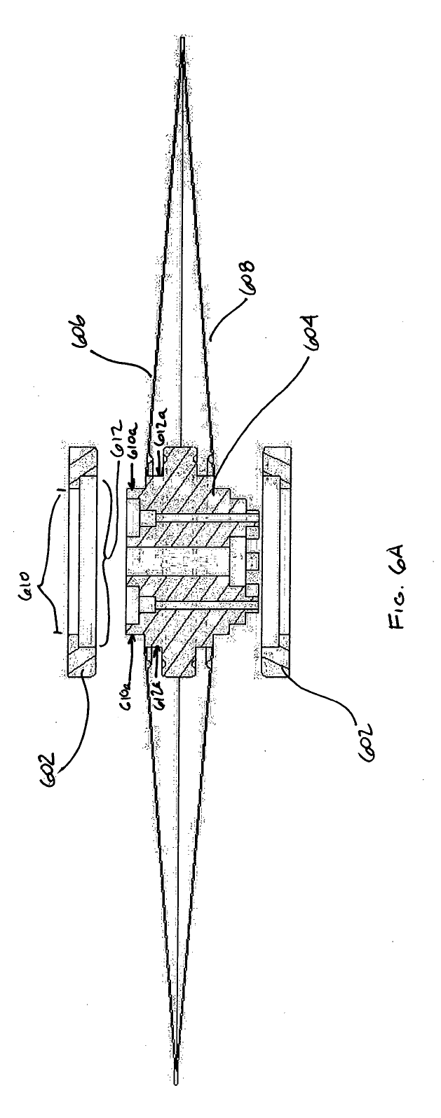

The hub allows multiple bags to be assembled together so that biological and/or other material sent to one or more processing bags may processed and expressed out of the centrifuge via the use of one or more expressor bags. In that regard, the '547 application discloses one or more arrangements of processing bags and expressor bags for processing. For example, FIG. 5 illustrates an assembly 500 of processing/expressor bags 502, coupled via coupling 504 to a multi-lumen line 506 (for example), so that fluids may be directed into and out of either or both of one or more of the processing bags and/or expressor bags. An example of such a multi-lumen line is disclosed in co-pending U.S. patent application Ser. No. 10/111,368, filed Oct. 27, 2000, entitled “Fluid Delivery Rope In some embodiments of the present invention, the processing/expressor bag includes a first mating portion for mating with a second mating portion of a hub. As shown in FIGS. 2A-2C, and FIGS. 3A-3D, the mating portions may include corresponding raised areas and recesses. For example, as shown in FIGS. 2A-2C, the processing/expressor bag may include a raised portion 210, which may be positioned adjacent the axial opening 208, and which may also radially (e.g., circumferentially) surround the opening on one or both sides of the bag. In this example, the raised portion includes a half-circle cross-section, which may act as a built in “O-ring”.

Correspondingly arranged on the hub, a recess 302 positioned on one or both sides of the hub receives the raised portion from a respective side of the bag 300. Of course, the mating portions may be reversed, such that the one or both sides of the bag may include a recess for accepting a corresponding raised portion of the hub. Furthermore, a series of alternating recesses and raised portions may be positioned on each corresponding mating surfaces in a cooperative arrangement.

One of skill in the art will recognize that the cross-sectional shape of the mating portions may be any shape sufficient to perform sealing. Thus, triangular, square, oval, rectangular and the like may be employed to mate the hub a respective sides of the bag together.

In some embodiments of the invention, the two mating portions are held together via a variety of means including mechanical and/or adhesive. In addition, other forms of joining the two mating surfaces may be used including ultra-sonic welding. Using an adhesive, for example, the following method may be performed for affixing sides of the bag to a respective side of the hub. A layer of adhesive may be applied to one or more of the mating surfaces of a respective side of each bag. In particular, the adhesive may be applied to the raised O-ring section provided on the inner portion of each side of the bag. The adhesive may also be applied to the respective recesses located on each respective side of the hub.

The two mating surfaces of the respective sides may then be brought together where the adhesive is allowed to cure. Depending upon the type of adhesive used, heat and/or pressure may be applied to the assembly so that the mating portions and/or adhesive cure properly and are sufficiently joined (i.e., to form an airtight seal for example). Other embodiments of the present invention may include other methods for assembling the hub and bag.

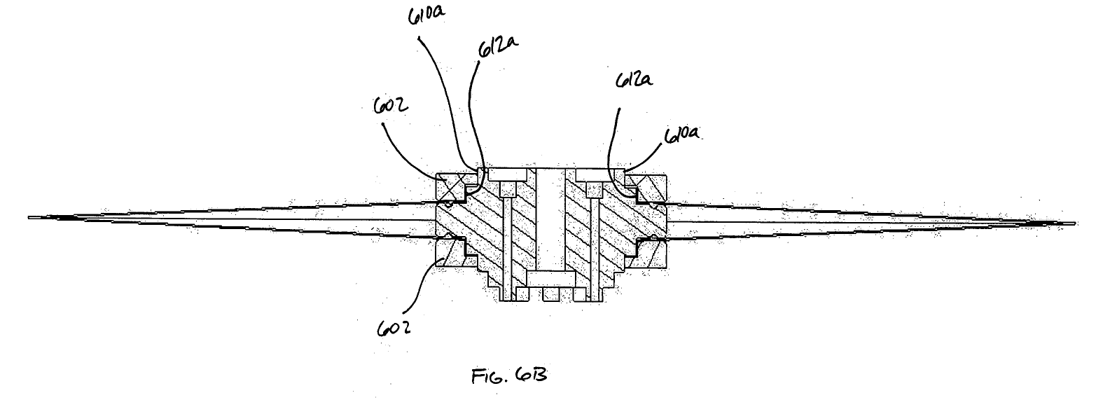

Alternatively, as shown in FIGS. 6A and 6B, or in addition to the process outlined above, one or more weld rings 602, may be used to affix the sides of the bag to the hub. The weld rings may be manufactured such that they include a central opening, which may include a first diameter 610 for receiving the collar area 610a of the hub, and may also include a second diameter for receiving a second collar area 612a near the radial barriers of the bag and corresponding recess in the hub. Accordingly, one or more of these diameters of the weld ring may be sized to frictionally fit a corresponding collar area of the hub, and press fit thereon. Alternatively, an adhesive may be used to affix the weld ring on the hub.

Accordingly, the hub-chamber/bag assembly systems and methods according to embodiments of the present invention establish an airtight seal, which prevents fluid from escaping the bags and/or air from entering therein.

Having now described some of the embodiments of the invention, it should be apparent to those skilled in the art that the foregoing is merely illustrative and not limiting, having been presented by way of example only. Numerous modifications and other embodiments are within the scope of ordinary skill in the art and are contemplated as falling within the scope of the invention. The contents of any references cited throughout this application are hereby incorporated by reference. The appropriate components, processes, and methods of those documents may be selected for the present invention and embodiments thereof.

1. A bag for use in centrifugal processing comprising a substantially circular enclosure having a central opening, wherein the central opening includes an integrally formed first mating portion for mating with a corresponding second mating portion of a hub.

2. The bag according to claim 1, wherein the first mating portion comprises an integrally molded radial barrier.

3. The bag according to claim 1, wherein the first mating portion comprises one or more recesses formed adjacent the opening and wherein the corresponding second mating portion is received by the one or more recesses.

4. The bag according to claim 1, wherein the first mating portion comprises one or more raised areas formed adjacent the opening and wherein the corresponding second mating portion receives the one or more raised areas.

5. The bag according to claim 2, wherein the radial barrier comprises a circumferential ring of raised material.

6. The bag according to claim 2, wherein the radial barrier comprises a circumferential recess.

7. The bag according to claim 1, wherein the bag includes a first side and a second side, and wherein each side include an opening for housing a respective side of the hub.

8. The bag according to claim 7, wherein each side includes a respective first mating portion for mating with a corresponding second mating portion of a respective side of the hub.

9. The bag according to claim 8, wherein the first mating portion comprises one or more recesses formed adjacent to a respective opening and wherein a respective corresponding second mating portion is received by the one or more recesses.

10. The bag according to claim 7, wherein a respective first mating portion comprises one or more raised areas formed adjacent to a respective opening and wherein a respective corresponding second mating portion receives the one or more raised areas.

11. The bag according to claim 1, wherein the bag is used as either or both of a processing and/or expressor bag.

12. The bag according to claim 7, further comprising at least one weld ring having a central opening for receiving a first side of the hub and a surface positioned adjacent the first side of the bag proximate the opening of the first side.

13. A bag for use in centrifugal processing comprising:
a substantially circular enclosure having a central opening, wherein the central opening includes an integrally formed first mating portion; and
a hub having a second mating portion corresponding to the first mating portion.

14. The bag according to claim 13, wherein the first mating portion comprises an integrally molded radial barrier.

15. The bag according to claim 13, wherein the first mating portion comprises one or more recesses formed adjacent to the opening and wherein the corresponding second mating portion is received by the one or more recesses.

16. The bag according to claim 13, wherein the first mating comprises one or more raised areas formed adjacent to the opening and wherein the corresponding second mating portion receives the one or more raised areas.

17. The bag according to claim 14, wherein the radial barrier comprises a circumferential ring of raised material.

18. The bag according to claim 14, wherein the radial barrier comprises a circumferential recess.

19. The bag according to claim 13, wherein the bag includes a first side and a second side, and wherein each side include an opening for housing a respective side of the hub.

20. The bag according to claim 19, wherein each side includes a respective first mating portion for mating with a corresponding second mating portion of a respective side of the hub.

21. The bag according to claim 20, wherein the first mating portion comprises one or more recesses formed adjacent to a respective opening and wherein a respective corresponding second mating portion is received by the one or more recesses.

22. The bag according to claim 20, wherein a respective first mating portion comprises one or more raised areas formed adjacent to a respective opening and wherein a respective corresponding second mating portion receives the one or more raised areas.

23. The bag according to claim 19, further comprising at least one weld ring having a central opening for receiving a first side of the hub and a surface positioned adjacent the first side of the bag proximate the opening of the first side.

24. A centrifuge comprising:
one or more bags for housing a material to be separated, wherein each bag comprises a substantially circular enclosure having a central opening, wherein the central opening includes an integrally formed first mating portion; and
one or more corresponding hubs, wherein each hub includes a second mating portion corresponding to the first mating portion of a respective bag.

25. The centrifuge according to claim 24, wherein the first mating portion comprises an integrally molded radial barrier.

26. The centrifuge according to claim 24, wherein the first mating portion comprises one or more recesses formed adjacent to the opening and wherein the corresponding second mating portion is received by the one or more recesses.

27. The centrifuge according to claim 24, wherein the first mating portion comprises one or more raised areas formed adjacent to the opening and wherein the corresponding second mating portion receives the one or more raised areas.

28. The centrifuge according to claim 25, wherein the radial barrier comprises a circumferential ring of raised material.

29. The centrifuge according to claim 25, wherein the radial barrier comprises a circumferential recess.

30. A method of sealing a centrifuge bag to a hub, comprising:
providing a bag for use in centrifugal processing, wherein the bag comprises a substantially circular enclosure having a central opening, wherein the central opening includes an integrally formed first mating portion; and
providing a hub having a second mating portion corresponding to the first mating portion;
placing the hub within the opening;
applying a layer of an adhesive material to at least one of the first mating portion and the second mating portion; and
mating the first mating portion with the second mating portion;
curing the adhesive material.

31. The method according to claim 30, further comprising curing the adhesive.

32. The method according to claim 30, wherein curing comprising applying at least one of heat, ultraviolet light and/or pressure to the mating portions.

33. The method according to claim 30, further comprising applying a layer of the adhesive around all or a portion of the opening.

34. A method of sealing a centrifuge bag to a hub, comprising:
providing a bag for use in centrifugal processing, wherein the bag comprises a substantially circular enclosure having a central opening, wherein the central opening includes a first mating portion; and
providing a hub having a second mating portion corresponding to the first mating portion;
placing the hub within the opening; and
mating the first mating portion with the second mating portion.

35. The method according to claim 34, wherein mating comprises welding the first mating portion to the second mating portion

36. The method according to claim 34, further comprising providing at least one weld ring having a central opening for receiving a first side of the hub and a surface positioned adjacent the first side of the bag proximate the opening of the first side.

37. The method according to claim 36, wherein mating comprises welding the weld ring to the hub.

38. The method according to claim 34, wherein mating comprises adhering the first mating portion to the second mating portion using at least one of heat, solvent bonding, pressure, ultra-violet light and adhesive.

39. A hub for use with a centrifugal bag comprising one or more channels for directing fluids into and/or out of a centrifuge bag, and an integrally formed first mating portion for mating with a corresponding second mating portion of the centrifuge bag.

40. The hub according to claim 39, wherein the first mating portion comprises an integrally molded radial barrier.

41. The hub according to claim 39, wherein the first mating portion comprises one or more recesses and wherein the corresponding second mating portion is received by the one or more recesses.

42. The hub according to claim 39, wherein the first mating comprises one or more raised areas formed adjacent the opening and wherein the corresponding second mating portion receives the one or more raised areas.

43. The hub according to claim 40, wherein the radial barrier comprises a circumferential ring of raised material.

44. The hub according to claim 40, wherein the radial barrier comprises a circumferential recess.

45. The hub according to claim 39, wherein the hub includes a first side and a second side, and wherein each side include a respective first mating portion for mating with a respective second mating portion of each side of a centrifuge bag.

46. The hub according to claim 45, wherein the first mating portion comprises one or more recesses wherein a respective corresponding second mating portion is received by the one or more recesses.

47. The hub according to claim 45, wherein the first mating portion comprises one or more raised areas and wherein a respective corresponding second mating portion receives the one or more raised areas.

48. The hub according to claim 39, further comprising at least one weld ring having a central opening for receiving a first side of the hub and a surface positioned adjacent the second mating portion of the bag proximate the hub.
